(19) United States
(12) Patent Application Publication
(10) Pub. No.: US 2007/0012507 A1
(43) Pub. Date: Jan. 18, 2007

(54) Head-band transducer by bone conduction

(76) Inventor: Richard H. Lyon, Belmont, MA (US)

Correspondence Address: STEVEN J WEISSBURG, 238 MAIN STREET, SUITE 303, CAMBRIDGE, MA, 02142, US

(21) Appl. No.: 11/475,845

(22) Filed: Jun. 27, 2006

Related U.S. Application Data
(60) Provisional application No. 60/695,486, filed on Jun. 30, 2005.

(51) Int. Cl. G10K 11/00; H04R 25/00

(52) U.S. Cl. 181/126

(57) ABSTRACT

A bone-conduction transducer in the form of a band encircling around a head carries piezoelectric elements that excite the head with signals that correspond to speech and/or audio. The head vibrates according to its modes of vibration, primarily of the skull. Direct connection to bones of the skull, such as by implant or extreme pressure, is not needed. Thus, comfort is enhanced, and so is effectiveness. The incoming signal is segmented into frequency bands, one for each of the modes of vibration of the head of interest. For each frequency band, the signal is processed to pass signals to the piezoelectric elements in a particular way to excite the relevant mode of vibration. Thus, sound is sensed by the user through vibration of the head. A head band carrying transducer elements may also be used to sense spoken sound, as a microphone. The piezoelectric transducer elements generate electromagnetic signals in response to the vibration of the head (which vibration is characterized by its modes) excited by speaking. The electromagnetic signals are processed to identify the modes being excited, and the intensity of the excitations. This mode signal is analyzed according to a model to determine a speech signal that has generated the head vibrations. That speech signal is generated as an electromagnetic signal, and may be sent as an output signal.

### RELATED DOCUMENTS

Benefit is hereby claimed to U.S. Provisional patent application 60/695,486 filed on Jun. 30, 2005, which is hereby fully incorporated by reference herein.

### DESCRIPTION

An invention hereof relates to the use of a novel bone-conduction transducer in the form of a band around the head that incorporates piezoelectric elements (also referred to herein as segments) that excite the head with speech and/or audio signals. Other bone conduction transducers rely on direct connection to the bones of the skull or on concentrated forces applied locally by a transducer. Such transducers are uncomfortable and may slip, reducing their effectiveness and acceptability.

An additional partial summary appears immediately preceding the claims.

### INTRODUCTION

Both military and civilian personnel are frequently expected to operate efficiently in very adverse conditions. A part of this function is the ability to communicate, possibly under conditions of high background noise. In addition, the person-to-person communication link will frequently need to be private and confidential. Enemy troops or unfriendly listeners may have the capability to listen in on radio transmissions, overhear a conversation, or read lips. These problems pose stringent requirements on the three primary aspects of a communications system:
1. Sensing the verbal message
2. Transmission and reception of signals
3. Presentation of the message to the listener (or receiver).

In the following sections, the use of inventions disclosed here as a part of a communication system is discussed. Inventions herein will be better understood with reference to the figures of the Drawing, which are:

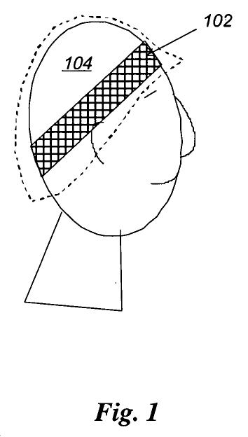

FIG. 1, which shows, schematically, a headband worn by a human user;

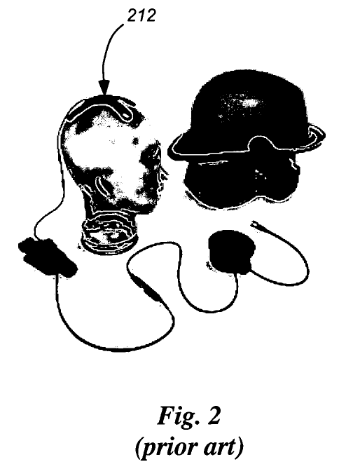

FIG. 2 which shows, schematically, several known means for sensing speech using a head mounted transducer;

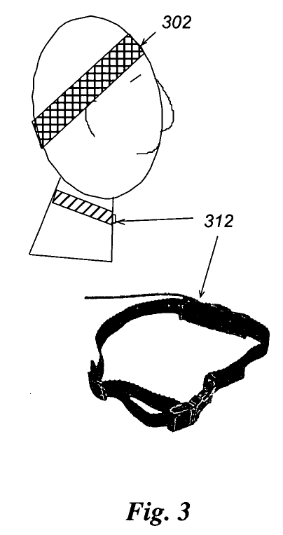

FIG. 3 which shows, schematically, a headband transducer of an invention hereof, and a throat mounted transducer;

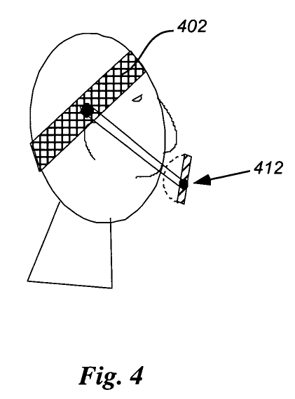

FIG. 4, which shows, schematically, a headband transducer of an invention hereof used with a privacy enhancing microphone;

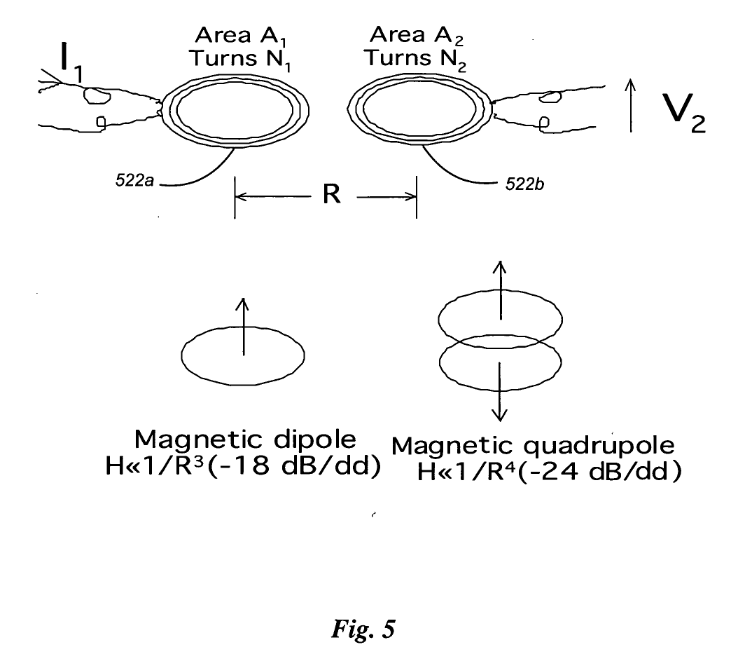

FIG. 5, which shows schematically, a dual loop inductive transducer;

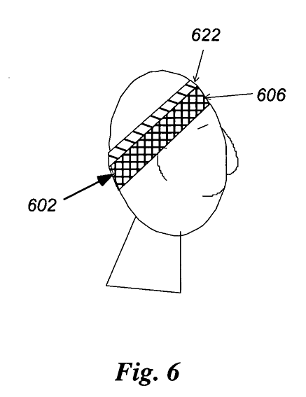

FIG. 6 which shows, schematically, a headband carrying both a dual loop inductive transducer and a segmented transducer for sensing and generating variations in mode of head shape vibration;

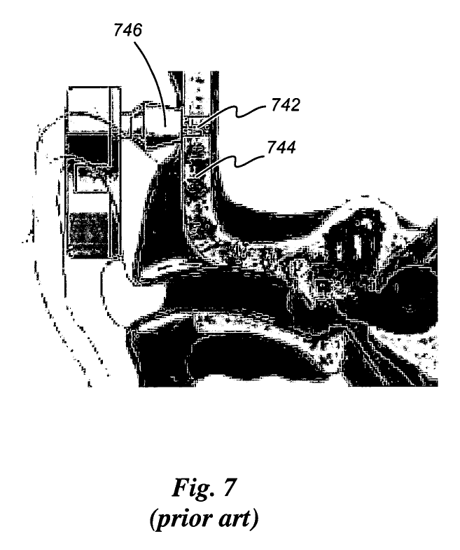

FIG. 7 which shows schematically in cross-section a known transducer that is implanted into a bone of the head;

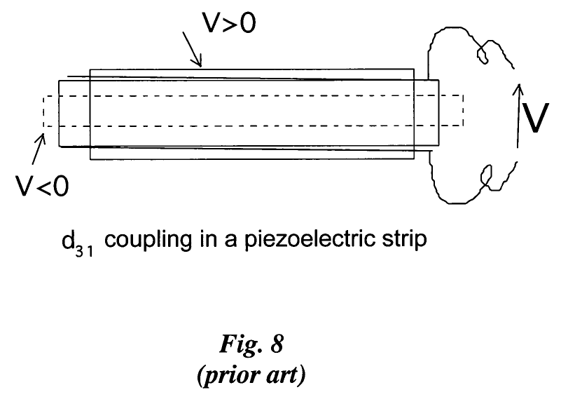

FIG. 8, which shows, schematically, in three superimposed images that represent positive, negative and neutral voltage, d₃₁ coupling in a piezoelectric strip;

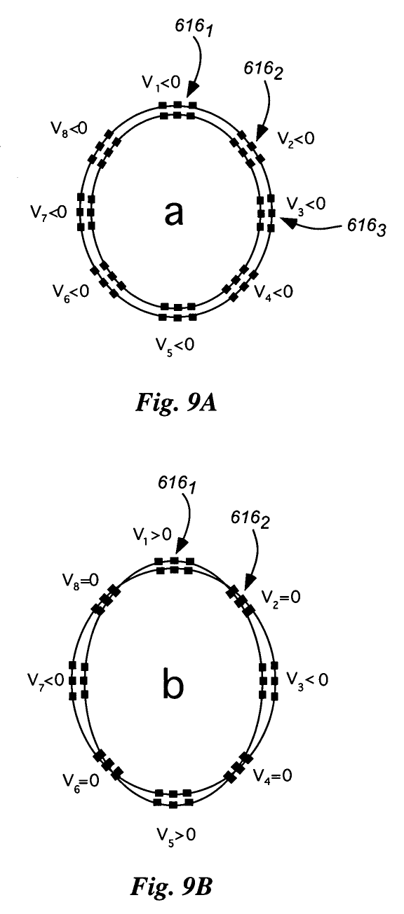

FIG. 9A, which shows, schematically, in a top view, a set of transducer elements operating in a breathing mode;

FIG. 9B, which shows, schematically in a top view a set of transducer elements operating in a squashing mode; and

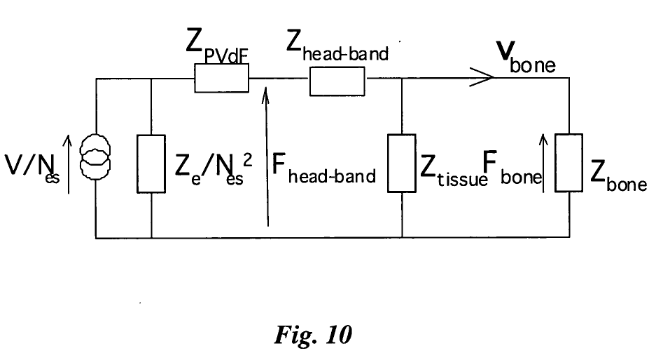

FIG. 10, which shows, schematically, an acoustical circuit model used for analyzing the transmission of acoustic energy between a human auditory system and a set of electromechanical transducer elements.

### Sensing the Verbal Message

Three different ways of sensing verbal spoken signals are described herein. The first is the use of a bone conduction transducer that will also be used for signal presentation to a listener. This system is sketched in FIG. 1. A headband strap 102 encircling around the head contains segments (not shown) of the flexible piezoelectric polymer PVdF (Poly Vinyledene di-Flouride). As the skull 104 and tissue vibrate in response to the vocal chords, the PVdF elements stretch and produce a signal that can then be transmitted to a listener over the selected communication link (discussed below). The distribution and inter-connections between the PVdF elements in the head band is an important part of transducer design.

A prior art microphone 212 designed to pick up skull vibrations using localized sensors, shown in FIG. 2, is marketed by Otto Communications.

The second way of picking up the verbal signal is to use a standard throat microphone as illustrated in FIG. 3. A throat microphone 312 has the possibility of being somewhat more vulnerable to ambient noise, since such noise will cause throat tissue too vibrate and be picked up, contaminating the speech signal.

The third method of sensing is PrivacyFone™, a proprietary development of RH Lyon Corp is described in application number PCT/US04/12363, entitled METHOD AND APPARATUS FOR SOUND TRANSDUCTION WITH MINIMAL INTERFERENCE FROM BACKGROUND NOISE AND MINIMAL LOCAL ACOUSTIC RADIATION, filed on Apr. 22, 2004, the complete disclosure of which is incorporated by reference, herein. It is a system that reduces voice radiation away from the talker to improve privacy, is directive toward the talker to reduce the intrusion of background noise, and can incorporate a small shield to reduce the opportunity for lip reading. A sketch of how this system might be incorporated with the headband PVdF transducer 402 is sketched in FIG. 4.

### Transmission of the Signal

Once a verbal signal is produced (by any of the three methods above) it must be transmitted to a listener. Since the signal exists as an electrical waveform, any conventional method—landline telephone, cell phone/radio, or optical can be used. Since landlines may not be available, and radio or optical transmission may not be secure, a method of transmission that does not produce far field radiation or distant signals, but allows for face to face communication in a high noise background will be useful.

For face to face or short range communications, an induction loop embedded in the same headband that contains the bone conduction PVdF elements can be used. In such a system, a current in one loop 522a worn by the talker will produce a voltage in the loop 522b worn by the listener as indicated in FIG. 5. [Rogers] (A complete list of references is at the end of this specification.) This signal decays rapidly (18 dB/double distance) with separation R between talker and listener. The relation between source current and receiver voltage is the usual mutual inductance formulation
V₂=L₁₂\dot{I}₁ (1)
where the mutual inductance
L₁₂=μₒN₁N₂A₁A₂/4πR³, (2)
and N is the number of turns in each loop and A is the area of each loop. R is the distance between talker loop 522a and listener loop 522b and μₒ=4π×10⁻⁷ (mks) is the magnetic permittivity of air.

This induction loop mode of propagation is attractive for security because its short range of propagation. Also, it is readily incorporated as a coil loop 622 into the headband 602 that contains the piezoelectric bone conduction transducer 606, as shown in FIG. 6.

### Bone Conduction Headband

Bone conduction transducers have been applied to the head in a variety of ways and in a variety of locations. A favorite is the mastoid bone behind the ear because it is both effective and relatively unobtrusive. Because of the tissue layer between the skin surface and the bones of the skull, sufficient force has to be applied locally to make good contact, and if the pressure is too great, the transducer becomes too uncomfortable to wear. When subjects have severe hearing loss, an implanted titanium stud 742 may be attached directly into the bone 744 as shown in FIG. 7. Then the transducer 746 is mounted directly onto the stud. This solution is of course not appropriate for hearing persons.

Disclosed herein is a different way of exciting the skull—with a band rather than with a localized transducer. Bone conduction in different frequency ranges involves different modes of vibration of the skull. [Hâkansson et al.] A headband 602 encircling around the head 601 that consists of segments of PVdF piezoelectric polymer strips or other piezoelectric elements 606 is to be programmed to provide forces on the head that match skull responsiveness in different frequency ranges. Since the force used to excite the skull is distributed along the band 602, the pressure exerted locally at any location on the head is much reduced. This head band excitation method is much more comfortable and easier to keep in place than a localized transducer.

There are about 10 modes of vibration of the human skull from about 500 to 5000 Hz. [Hâkansson et al.] These modes are moderately damped (they have an average damping ratio of 5% or a Q value of about 10). Since the actual resonance frequencies vary from one individual to another, it will not be possible to match exactly the mode shapes of individuals with the excitation patterns of the segmented PVdF transducer. But the same problem exists for any “point applicator” of force for bone conduction. An excitation pattern that provides an acceptable quality of perceived sounds and speech recognition must be employed.

When the force on the head is localized as it is for most bone, conduction transducers, then there is a local deformation that is well known in structural acoustics to be a radiator of sound. [Fahy] The head-band transducer excites the skull by contraction and elongation of segments of the band, producing mostly forces parallel to the surface of the skin. These forces and the distortions will result in much less sound radiation from the head and more secure communications.

### System Considerations

The three elements of the system described here—sensing, transmission, and presentation—work best if they work together seamlessly. If the head band PVdF elements 606 are used for both verbal sensing and presentation (stimulation), then they should preferably either be composed of separate elements, or switched as the need arises. If the head band 602 also contains the induction loop 622 for transmission/reception as shown in FIG. 6, then cross talk between the PVdF elements and the loop must be controlled. And, the power required for the system, its weight, and bulk must all be kept within manageable limits.

Finally, it should be noted that a bone conduction headband disclosed here can have an application apart from that discussed above. Military programs are concerned about protection of personnel to very high levels of ambient noise of the order of 150 dB. [DoD Solicitation 05.1] Active noise reduction earplugs are being developed as a part of that program. At these levels, bone conduction becomes a limiting path that limits the effectiveness of ANR earplugs. This is even truer when the ear canal is occluded by the earplug. The headband system disclosed here could be a useful supplement to the ANR earplugs as a way of canceling some of the noise that enters through the bone conduction path.

### Stress Patterns for Skull Mode Excitation

A head-band method disclosed here uses strip piezoelectric segments to excite the skull into vibration. This type of excitation is most appropriate for the application of shear or in-plane stresses to a surface. The surface stretching patterns for skull vibrations determine the patterns of excitation to be applied by the head-band.

Piezoelectric materials in general have a “d₃₁ coupling” which causes them to shrink or elongate in one direction as an electrical field is applied in an orthogonal direction, as shown in FIG. 8, showing the strip at rest for V=0, streteched (dotted) for V<0, and contracted for V>0. When these strips 616₁, 616₂ . . . are segmented and placed in a head-band, their responses of stretching and contracting can be phased as shown in FIG. 9 to excite a particular pattern of skull vibration. In sketch 9a the elements are phased so that a breathing mode is excited, while in sketch 9b, the driving voltage is phased so that a squashing mode is excited. Since these modes resonate at different frequencies, the pattern of excitation must shift for different parts of the frequency spectrum according to the shapes of the modes to be excited.

### Segment Shapes and Deflections Required to Excite Skull Modes

Once the surface deflection patterns have been established, the pattern of deflections needed in the head-band to best excite the modes is determined. The geometry of the head-band will favor excitation of some modes, but not others. The layout and excitation levels for the PVdF segments 616 in the band to achieve the most favorable results are a part of a design. Such a design must include any effects of the internal stiffness of the head-band and the layer of skin and tissue between the head-band and the bone.

The stretching and contraction of the PVdF elements shown in FIG. 8 cause forces to be produced in the head-band according to an electrostatic coupling coefficient [Hueter et al.]
Nₑₛ=KL/Yₒwhd₃₁ (3)
where K is a constant on the order of unity that depends on the mode being driven, and the piezoelectric segment parameters are the strip length L, width w, thickness h, Young's modulus Yₒ, and piezoelectric strain coefficient d₃₁.

The analytic model used to compute the (generalized) force on the bone due to voltage applied to the PVdF segments is shown in FIG. 10. The electrical impedance of the PVdF strips 616 is Zₑ, that of a capacitance. The mechanical impedance of the PVdF strips 616 and the head-band 602 are Z_{PVdF} and Z_{head-band} respectively. The impedance of the layer of tissue between the head-band and the bone is Zₜᵢₛₛᵤₑ, which reduces the motion and force at the skull, represented by Z_{bone}. It is the motion of the skull bone that is of interest and defines the motions transmitted to the inner ear.

These parameters are evaluated so that predictions can be made of the vibrations of the skull. The model is a design tool since the shapes, dimensions, and arrangement of the piezoelectric segments can be modified and the model used to optimize for vibration transmission.

In general, when used as a speaker, to produce sound to be heard by the user wearing the headband, a sound signal from an external source is provided to a processor. The processor segments, such as by filtering, the signal into several parts of the frequency spectrum, the parts being referred to here as frequency bands. For each frequency band, there may be an individual additional processor, or a suitably programmed and powerful single processor may accomplish all functions. Each frequency band is associated with a particular mode of vibration of a human skull. Each mode is also associated with a mode set of transducer elements, which, if energized in a particular pattern, will best excite the mode. Each mode set of transducer elements may include all, or only some of the transducer elements, depending on the shapes of the modes and head transmission characteristics. For each frequency band, the respective processor determines the excitation level to use to excite the transducer segments to excite the mode associated with that frequency band at an amplitude that corresponds with the amplitude of the frequency band relative to the other bands. The appropriate signal is sent to each segment, and the group of segments as a whole stretch and contract, applying stresses to the skull that cause it to vibrate in such a way as to generate a sensation of sound that corresponds to the original signal.

Conversely, yet still in general, a headband can be used as a microphone, to sense sound spoken by a user wearing the headband, and sent as an electronic signal to an external receiver, where perhaps it will be transduced into audible sound. Electronic signals are produced by the transducer elements in the headband, and are provided to a processor. The processor may be a single processor that performs all of the functions, or it may be a plurality of processors. For instance, each of a plurality of processors may be associated with a single frequency band, or a single mode of vibration of the skull.

Excitation of each mode of the skull by the user speaking is characterized primarily within a frequency band. The processor or processors sense the vibration signal for each relevant frequency band, and from those vibration signals, determine the modes of vibration that have been excited. Basically, for each frequency band, the processor combines outputs from all of the transducer segments in a particular way for that band. The result represents the mixture of modes of vibration of the skull. From these mode signals, using the model shown in FIG. 10, the spoken signal can be recovered, and reproduced.

### Partial Summary

Inventions disclosed and described herein include (but are not limited to methods of sensing speech, and generating a head shape vibration signal that corresponds to speech, as well as apparatus for conducting each method, and both methods simultaneously.

Thus, this document discloses many related inventions.

An invention described herein is a transducer, mountable upon a human head, comprising: a mounting member, adapted to releasably engage a human head; a plurality of at least two electromechanical transducer elements, each transducer element spaced apart from each other transducer element and supported by the mounting member to contact a bony region of a human head, at a location spaced from an ear opening; and an electronic channel adapted to couple the plurality of transducer elements to at least one processor.

According to preferred embodiments, the mounting member may comprise a head band, a skull cap, or a combination thereof, or any other head encircling structure.

According to yet another preferred embodiment, a first subset of the plurality of transducer elements are spaced apart to contact a human head at locations that correspond to a first mode of vibration of a human head.

Still another preferred embodiment further comprises a second subset of the plurality of transducer elements being spaced apart to contact a human head at locations that correspond to a second mode of vibration of a human head. A related embodiment may further comprise a processor adapted to take as an input a plurality of electromagnetic signals, each input signal generated by a subset of the plurality of electromagnetic transducer elements, which subset, is excited by a human head vibrating in at least one mode of vibration, and to generate as an output, an electromagnetic signal.

Yet another preferred embodiment comprises a plurality of transducer elements being spaced apart to contact a human head at locations that correspond to at least three modes of vibration of a human head.

Various preferred embodiments envision each electromechanical transducer element comprising a transducer element that, when carried by the mounting member and worn on a human head, produces motion parallel to a surface of the head.

For a typical embodiment of an invention hereof, the electromechanical transducer elements comprise strip piezoelectric transducer elements.

A very important embodiment of an invention hereof, further comprises a processor adapted to take as an input an electromagnetic signal, and to generate as an output, a plurality of signals, each signal directed to a subset of the plurality of electromechanical transducer elements, which subset, when energized, excite a mode of vibration of a human head. A related embodiment further comprises a processor adapted to take as an input a plurality of electromagnetic signals, each input signal generated by a plurality of electromagnetic transducer elements that may be different from the plurality of electromagnetic transducer elements which, when energized, excite a mode of vibration of a human head, and to generate as an output an electromagnetic signal.

Still another important embodiment of an invention hereof further comprises a processor adapted to take as an input an electromagnetic signal and to generate as an output an electromagnetic signal that corresponds to the input signal segregated into parts of the frequency spectrum. A closely related embodiment further comprises a processor adapted to take as an input a plurality of electromagnetic signals, each input signal generated by the plurality of electromagnetic transducer elements and to generate as an output, an electromagnetic signal

A related embodiment of an invention hereof further comprises, a plurality of processors, each adapted to take as an input an electromagnetic signal limited by a part of the frequency spectrum, and to generate as an output, a plurality of signals, each output signal directed to an electromechanical transducer element that is part of a mode set, which mode set, when energized, excites a mode of vibration of a human head, which excited mode corresponds to the limited frequency range.

Yet another related embodiment of an invention hereof further comprises, a plurality of processors, each adapted to take as an input an electromagnetic signal limited by a part of the frequency spectrum, and to generate as an output, a plurality of signals, each output signal directed to an electromechanical transducer element that is part of a subset of transducer elements, which subset, when energized, excites a mode of vibration of a human head, which excited mode corresponds to the limited frequency range.

In yet another preferred embodiment, each electromechanical transducer element comprises a piezoelectric strip adapted to cause a stress to a head adjacent the respective transducer element, related to elongation and contraction of the strip through an electrostatic coupling coefficient Nₑₛ, defined as Nₑₛ=KL/Yₒwhd₃₁, where K is a constant of the order of unity, which depends on the mode being driven, L is electromagnetic transducer element length, w is electromagnetic transducer element width, h is electromagnetic transducer element thickness, Yₒ is Young's modulus of the strip and d₃₁ is a piezoelectric strain coefficient for the transducer element material.

According to another preferred embodiment, the electromagnetic channel comprises a wireless channel. Or, it may comprise a wired channel.

Another embodiment that is preferred is where each electromechanical transducer element comprises a transducer element that, when carried by the mounting member and worn on a human head, responds to an input of change of head shape by producing an electromagnetic signal.

Or, similarly, each electromechanical transducer element may comprises a transducer element that, when carried by the mounting member and worn on a human head, takes as an input mechanical vibration of the head that occurs during speech of the human, and produces an electromagnetic signal that corresponds to the speech.

Another embodiment of an invention hereof is a method for presenting a signal to a human auditory sense, the method comprising the steps of: releasably engaging a transducer mounting member to a human head, which mounting member carries a plurality of at least two electromechanical transducer elements, the transducer elements spaced apart from each other and supported by the mounting member to contact a bony region of the head, at locations that correspond to at least two modes of vibration of a human head; coupling the plurality of transducer elements to at least one processor that takes as an input, an electromagnetic signal that corresponds to an acoustic signal; and generating with the at least one processor a plurality of electromagnetic signals, each signal directed to a set of at least two transducer elements, each set configured to excite a mode of vibration of a human head in a manner that corresponds to the acoustical signal.

With related embodiments, the step of releasably engaging the transducer elements to a head comprises providing a headband that carries the transducer elements and engaging the headband around a head, or providing a cap that carries the transducer elements and engaging the cap upon a head, or both.

An important embodiment of a method of an invention hereof further comprises the step of segregating the electromagnetic signal into a plurality of parts of a frequency spectrum. That may further comprise generating a signal for each of the plurality of parts of the frequency spectrum. The step of generating a signal for one part of the frequency spectrum may comprise generating a signal configured to excite a mode of vibration of a human skull.

Yet another related but different important embodiment of an invention hereof is a method for transducing a speech signal spoken by a human user to an electromagnetic signal. The method comprises: releasably engaging a transducer mounting member to a human head, which mounting member carries a plurality of at least two electromechanical transducer elements, the transducer elements being spaced apart from each other and supported by the mounting member to contact a bony region of the head, at locations that correspond to at least two modes of vibration of a human head excited by the human speaking; coupling the plurality of transducer elements to at least one processor that takes as inputs, a plurality of electromagnetic signals, each of which corresponds to a mode of vibration of the human head that is excited by the human speaking; and generating with the processor an electromagnetic signal, that corresponds to speech spoken by the human speaking. The step of generating with the processor an electromagnetic signal may conveniently comprise the step of establishing among the transducer elements a plurality of sets of transducer elements, and establishing a plurality of parts of a frequency spectrum of a signal to be generated by the processor and, for each part of the frequency spectrum, combining outputs from the plurality of sets of transducers in a particular manner, as compared to for each other part of the frequency spectrum to generate an electromagnetic signal that comprises components from each of the parts of the frequency spectrum.

Many techniques and aspects of the inventions have been described herein. The person skilled in the art will understand that many of these techniques can be used with other disclosed techniques, even if they have not been specifically described in use together. For instance, the techniques described for using a head band transducer as a microphone can be used alone, or with a head band transducer that is also used as a speaker. Transducer elements may be carried by a head band, or a cap, or both, in the same device. The methods of sensing head bone mode vibration can be used with the piezoelectric hardware discussed, or any other suitable transducer that senses the change of shape of the human head. Similarly, the methods of exciting head bone mode vibration can be used with the piezoelectric hardware discussed, or any other suitable transducer that causes suitable changes of shape of the human head.

This disclosure describes and discloses more than one invention, including apparatus for sensing speech, for generating a signal that corresponds with speech, and for doing both in one apparatus. This disclosure also describes a method of sensing speech and a method of generating a head shape displacement signal that corresponds to speech. The inventions are set forth in the claims of this and related documents, not only as filed, but also as developed during prosecution of any patent application based on this disclosure. The inventors intend to claim all of the various inventions to the limits permitted by the prior art, as it is subsequently determined to be. No feature described herein is essential to each invention disclosed herein. Thus, the inventors intend that no features described herein, but not claimed in any particular claim of any patent based on this disclosure, should be incorporated into any such claim.

Some assemblies of hardware, or groups of steps, are referred to herein as an invention. However, this is not an admission that any such assemblies or groups are necessarily patentably distinct inventions, particularly as contemplated by laws and regulations regarding the number of inventions that will be examined in one patent application, or unity of invention. It is intended to be a short way of saying an embodiment of an invention.

An abstract is submitted herewith. It is emphasized that this abstract is being provided to comply with the rule requiring an abstract that will allow examiners and other searchers to quickly ascertain the subject matter of the technical disclosure. It is submitted with the understanding that it will not be used to interpret or limit the scope or meaning of the claims, as promised by the Patent Office's rule.

The foregoing discussion should be understood as illustrative and should not be considered to be limiting in any sense. While the inventions have been particularly shown and described with references to preferred embodiments thereof, it will be understood by those skilled in the art that various changes in form and details may be made therein without departing from the spirit and scope of the inventions as defined by the claims.

The corresponding structures, materials, acts and equivalents of all means or step plus function elements in the claims below are intended to include any structure, material, or acts for performing the functions in combination with other claimed elements as specifically claimed.

Documents mentioned:
1. W. E. Rogers, Electric Fields (McGraw-Hill Book Co., Inc., New York, 1954), Section 11.8
2. B. Hâkansson, A. Brandt, and P. Carlsson, “resonance frequencies of the human skull in vivo”, J. Acoust. Soc. Am., vol 95, No. 3, March 1994 pp 1474-1481
3. F. Fahy, Sound and Structural Vibration (Academic Press, London 1985), Section 2.7.
4. Example: DoD SBIR Solicitation 05.1, Topic F051-057 “Advanced Subminiature Loudspeaker/Earphone Driver” January 2005
5. T. F. Hueter and R. H. Bolt, Sonics (John Wiley & Sons, New York 1955) Section 4.3

What is claimed is:

1. A transducer mountable upon a human head, the transducer comprising:
a. a mounting member, adapted to releasably engage a human head;
b. a plurality of at least two electromechanical transducer elements, each transducer element spaced apart from each other transducer element and supported by the mounting member to contact a bony region of a human head, at a location spaced from an ear opening; and
c. an electronic channel adapted to couple the plurality of transducer elements to at least one processor.

2. The transducer of claim 1, the mounting member comprising a head band.

3. The transducer of claim 1, the mounting member comprising a skull cap.

4. The transducer of claim 1, a first subset of the plurality of transducer elements being spaced apart to contact a human head at locations that correspond to a first mode of vibration of a human head.

5. The transducer of claim 4, a second subset of the plurality of transducer elements being spaced apart to contact a human head at locations that correspond to a second mode of vibration of a human head.

6. The transducer of claim 1, the plurality of transducer elements being spaced apart to contact a human head at locations that correspond to a plurality of modes of vibration of a human head.

7. The transducer of claim 1, each electromechanical transducer element comprising a transducer element that, when carried by the mounting member and worn on a human head, produces motion parallel to a surface of the head.

8. The transducer of claim 1, the electromechanical transducer elements comprising strip piezoelectric transducer elements.

9. The transducer of claim 6, further comprising a processor adapted to take as an input an electromagnetic signal, and to generate as an output, a plurality of signals, each signal directed to a subset of the plurality of electromechanical transducer elements, which subset, when energized, excite a mode of vibration of a human head.

10. The transducer of claim 6, further comprising a processor adapted to take as an input an electromagnetic signal and to generate as an output an electromagnetic signal that corresponds to the input signal segregated into parts of the frequency spectrum.

11. The transducer of claim 6, further comprising, a plurality of processors, each adapted to take as an input an electromagnetic signal limited by a part of the frequency spectrum, and to generate as an output, a plurality of signals, each output signal directed to an electromechanical transducer element that is part of a mode set, which mode set, when energized, excites a mode of vibration of a human head, which excited mode corresponds to the limited frequency range.

12. The transducer of claim 6, further comprising, a plurality of processors, each adapted to take as an input an electromagnetic signal limited by a part of the frequency spectrum, and to generate as an output, a plurality of signals, each output signal directed to an electromechanical transducer element that is part of a subset of transducer elements, which subset, when energized, excites a mode of vibration of a human head, which excited mode corresponds to the limited frequency range.

13. The transducer of claim 7, each electromechanical transducer element comprising a piezoelectric strip adapted to cause a stress to a head adjacent the respective transducer element, related to elongation and contraction of the strip through an electrostatic coupling coefficient Nₑₛ, defined as
Nₑₛ=KL/Yₒwhd₃₁,
where K is a constant of the order of unity, which depends on the mode being driven, L is electromagnetic transducer element length, w is electromagnetic transducer element width, h is electromagnetic transducer element thickness, Yₒ is Young's modulus of the strip and d₃₁ is a piezoelectric strain coefficient for the transducer element material.

14. The transducer of claim 1, the electromagnetic channel comprising a wireless channel.

15. The transducer of claim 1, the electromagnetic channel comprising a wired channel.

16. The transducer of claim 1, each electromechanical transducer element comprising a transducer element that, when carried by the mounting member and worn on a human head, responds to an input of change of head shape by producing an electromagnetic signal.

17. The transducer of claim 1, each electromechanical transducer element comprising a transducer element that, when carried by the mounting member and worn on a human head, takes as an input mechanical vibration of the head that occurs during speech of the human, and produces an electromagnetic signal that corresponds to the speech.

18. The transducer of claim 6, further comprising a processor adapted to take as an input a plurality of electromagnetic signals, each input signal generated by a subset of the plurality of electromagnetic transducer elements, which subset, is excited by a human head vibrating in at least one mode of vibration, and to generate as an output, an electromagnetic signal.

19. The transducer of claim 6, further comprising a processor adapted to take as an input a plurality of electromagnetic signals, each input signal generated by an electromagnetic transducer element and to generate as an output, an electromagnetic signal.

20. The transducer of claim 9, further comprising a processor adapted to take as an input a plurality of electromagnetic signals, each input signal generated by the plurality of electromagnetic transducer elements and to generate as an output an electromagnetic signal.

21. The transducer of claim 20, further comprising a switch to switch signal direction between a direction from a processor to the electromagnetic transducer elements, and a direction from the electromagnetic transducer elements to a processor.

22. The transducer of claim 9, further comprising a processor adapted to take as an input a plurality of electromagnetic signals, each input signal generated by a plurality of electromagnetic transducer elements that may be different from the plurality of electromagnetic transducer elements which, when energized, excite a mode of vibration of a human head, and to generate as an output an electromagnetic signal.

23. A method for presenting a signal to a human auditory sense, the method comprising the steps of:
a. releasably engaging a transducer mounting member to a human head, which mounting member carries a plurality of at least two electromechanical transducer elements, the transducer elements spaced apart from each other and supported by the mounting member to contact a bony region of the head, at locations that correspond to at least two modes of vibration of a human head;
b. coupling the plurality of transducer elements to at least one processor that takes as an input, an electromagnetic signal that corresponds to an acoustic signal; and
c. generating with the at least one processor a plurality of electromagnetic signals, each signal directed to a set of at least two transducer elements, each set configured to excite a mode of vibration of a human head in a manner that corresponds to the acoustical signal.

24. The method of claim 23, the step of releasably engaging the transducer elements to a head comprising providing a headband that carries the transducer elements and engaging the headband around a head.

25. The method of claim 23, the step of releasably engaging the transducer elements to a head comprising providing a cap that carries the transducer elements and engaging the cap upon a head.

26. The method of claim 23, further comprising the step of segregating the electromagnetic signal into a plurality of parts of a frequency spectrum.

27. The method of claim 26, the step of generating a plurality of signals comprising generating a signal for each of the plurality of parts of the frequency spectrum.

28. The method of claim 27, the step of generating a signal directed to a set of transducer elements comprising generating a signal directed to a set of transducer elements for one part of the frequency spectrum.

29. The method of claim 28, the step of generating a signal for one part of the frequency spectrum comprising generating a signal configured to excite a mode of vibration of a human skull.

30. A method for transducing a speech signal spoken by a human user to an electromagnetic signal, the method comprising:
a. releasably engaging a transducer mounting member to a human head, which mounting member carries a plurality of at least two electromechanical transducer elements, the transducer elements being spaced apart from each other and supported by the mounting member to contact a bony region of the head, at locations that correspond to at least two modes of vibration of a human head excited by the human speaking;
b. coupling the plurality of transducer elements to at least one processor that takes as inputs, a plurality of electromagnetic signals, each of which corresponds to a mode of vibration of the human head that is excited by the human speaking; and
c. generating with the processor an electromagnetic signal, that corresponds to speech spoken by the human speaking.

31. The method of claim 30, the step of generating with the processor an electromagnetic signal comprising the step of establishing among the transducer elements a plurality of sets of transducer elements, and establishing a plurality of parts of a frequency spectrum of a signal to be generated by the processor and, for each part of the frequency spectrum, combining outputs from the plurality of sets of transducers in a particular manner, as compared to for each other part of the frequency spectrum to generate an electromagnetic signal that comprises components from each of the parts of the frequency spectrum.
